(19) United States
(12) Patent Application Publication
(10) Pub. No.: US 2020/0198271 A1
(43) Pub. Date: Jun. 25, 2020

(54) METHOD OF MAKING COMPOSITE INNERLINER

(71) Applicant: The Goodyear Tire & Rubber Company, Akron, OH (US)

(72) Inventors: Hongbing Chen, Broadview Heights, OH (US); Christopher David Dyrlund, Canton, OH (US); Elizabeth Amelia Rogenski, Atwater, OH (US); Joshua Aaron Phillipson, Brecksville, OH (US); Duane Thomas Delaney, Canton, OH (US)

(21) Appl. No.: 16/587,556

(22) Filed: Sep. 30, 2019

Related U.S. Application Data
(60) Provisional application No. 62/781,763, filed on Dec. 19, 2018.

(51) Int. Cl. B29D 30/06; B29C 48/21; B29C 48/30

(52) U.S. Cl. CPC B29D 30/0681; B29D 2030/0682; B29C 48/304; B29C 48/21

(57) ABSTRACT

A method for forming a tire having a composite innerliner is described wherein the method includes the following steps: forming a coextruded strip of a first compound and a second compound, wherein the first compound may be an air impermeable compound, and the second compound is a cross linkable diene rubber compound, winding the coextruded strip onto a tire building drum while varying the ratio of the first compound to the second compound to form an inner liner layer of spirally wound coextruded strips.

### FIELD OF THE INVENTION

The invention relates in general to tire manufacturing, and more particularly to an apparatus for forming tire components and a tire, and more particularly to a method of making a composite innerliner, and a tire with a composite innerliner.

### BACKGROUND OF THE INVENTION

Tire manufacturers have progressed to more complicated designs due to an advance in technology as well as a highly competitive industrial environment. In particular, tire designers seek to use multiple rubber compounds in a tire component such as the tread in order to meet customer demands. In order to improve manufacturing efficiency, strip lamination of a continuous strip of rubber is often used to build a tire or tire component.

One tire component of interest is the tire innerliner, which functions to prevent air loss from the tire. Rubbers such as butyl or halobutyl rubber are often used as a major portion of the innerliners. One problem that occurs when strip laminating the tire innerliner is low adhesion of the strip to the adjacent ply layer. Poor adhesion between the inner liner and ply can result in tire defects, resulting in the need to scrap the tire. Increasing the stitcher pressure to ensure adhesion does not solve the problem. Also, using a lower butyl rubber formulation to enhance adhesion typically results in a heavier liner, increasing the weight of the tire.

Thus, an improved innerliner design and method of making is desired which overcomes the aforementioned disadvantages.

### Definitions

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

### BRIEF DESCRIPTION OF THE DRAWINGS

The invention will be described by way of example and with reference to the accompanying drawings in which:

FIG. 1 is a cross-sectional view of a tire of the present invention;

FIG. 2 is a cross-sectional view of a complex innerliner of the present invention;

FIG. 3 is a front perspective view of a dual compound strip;

FIG. 4 is a cross-sectional view of a dual compound strip;

FIG. 5 is a front view of a dual innerliner configuration that was strip-laminated directly onto a tire building machine;

FIG. 6 is a cross-sectional view of a dual compound extruder apparatus;

FIG. 7 is a perspective cutaway view of a coextrusion nozzle of the present invention; and

FIG. 8 is a side cross-sectional view of the coextrusion nozzle of FIG. 4.

### DETAILED DESCRIPTION OF THE INVENTION

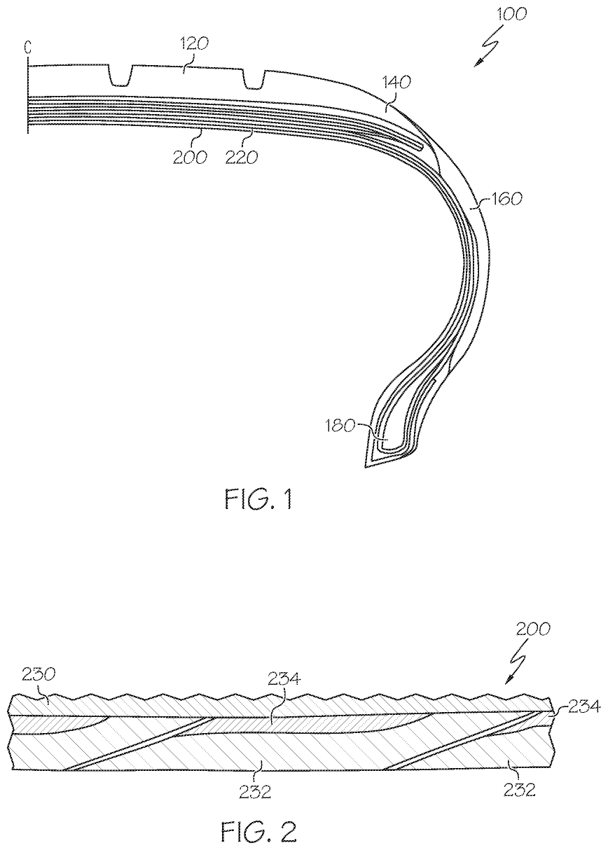

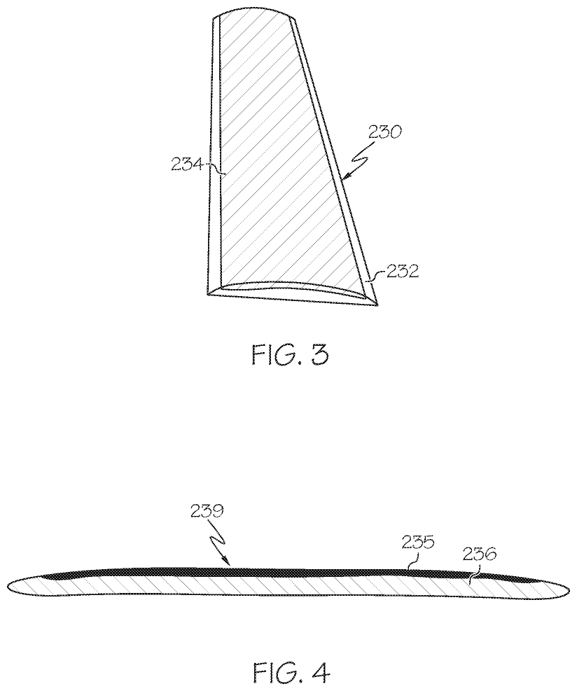

FIG. 1 illustrates a pneumatic radial tire 100 of the present invention. The tire as shown is a passenger tire, but the invention as described herein is not limited to a passenger tire and may be used for other types of tires such as truck or OTR tires. The tire is a conventional tire, and has a ground-engaging tread 120, sidewalls 160 that extend radially inwards from the shoulders 140 and terminate in a pair of bead portions 180. The tire 100 has a carcass reinforcing structure 220 that is anchored in a respective bead portion 180. The carcass reinforcing structure 220 comprises at least one reinforcing ply. An inner liner 200 of the present invention is located radially inward of the ply layer. The inner liner is formed from a continuous dual compound coextruded strip 230, as shown in FIG. 3.

The coextruder strip 230 is formed of a first discrete layer 232 of a first compound joined to a discrete second layer 234 of a second compound. The first and second compounds are not mixed together to form the coextruded strip 230, and are only joined together at an interface. The first compound 232 is preferably formed of an impermeable material such as butyl, bromobutyl, and halobutyl rubber as well as any material with the air permeability characteristics of butyl, bromobutyl, or halobutyl rubber. The first layer thickness of the impermeable material is preferably in the range of about 0.3 mm to about 2 mm, and more preferably in the range of about 0.6 to about 1.2 mm. The second compound is preferably ply coat or ply compound, and has a thickness in the range of about 0.01 mm to about 0.2 mm, more preferably about 0.01 mm to about 0.1 mm. The overall width of the strip 230 is in the range of about 10 mm to about 50 mm, more preferably 20-40 mm. The term “about” as used herein means a variation of +/−10%.

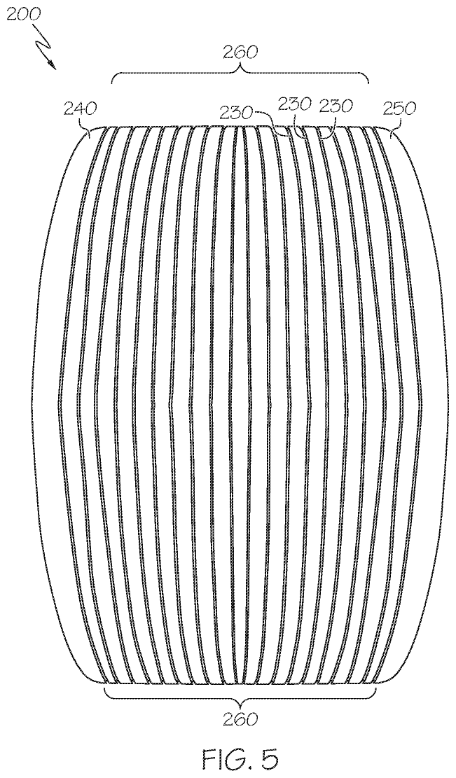

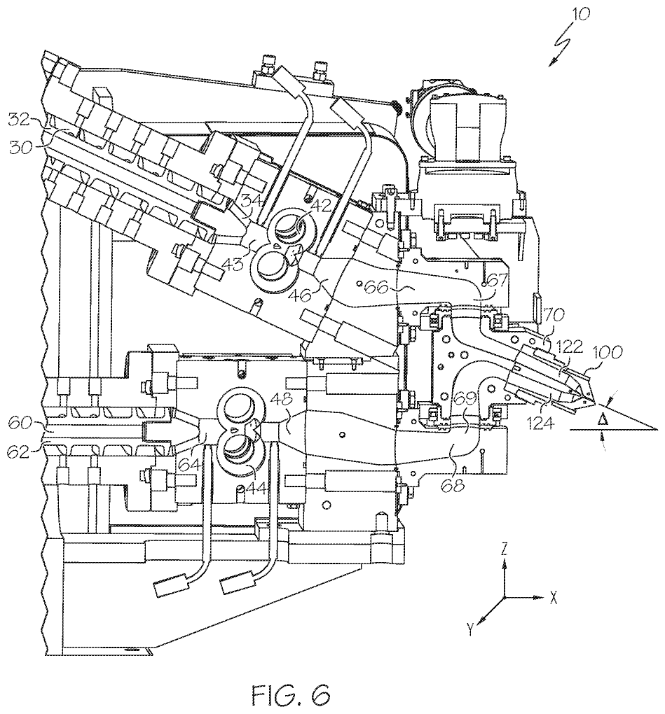

The ratio of the first compound to the second compound of the strip may be varied almost instantaneously by the dual extruder apparatus 10 shown in FIG. 6. In one example, FIG. 3 illustrates a dual compound strip 230 formed of a first compound 232 (for purposes of illustration) and second compound 234. The dual compound strip is made of 90% of the first compound, and 10% of the second compound. FIG. 4 is a cross-sectional view of a second embodiment of a dual compound strip 239, comprised of a 90% butyl rubber layer 236 and 10% ply coat strip 235.

FIG. 5 illustrates an inner liner configuration 200 of the present invention, that is formed by spirally winding a coextruded dual compound strip 230. The inner liner configuration 200 has outer lateral ends 240,250 and a middle portion 260. At the middle portion of the inner liner configuration, the dual compound strip 230 has a ratio in the range of 80-100% impermeable material to 20% or less ply coat. The outer lateral ends 240,250 have a different ratio, wherein the strip is preferably formed of 90-100% ply compound.

Dual compound Extruder Apparatus

FIG. 5 illustrates a first embodiment of a dual compound extruder apparatus 10 suitable for use for making the coextruded strip 230. The dual compound extruder apparatus 10 extrudes a continuous coextruded strip of two compounds directly onto a tire building drum, or tire carcass or component building apparatus.

As shown in FIG. 6, the dual compound extruder apparatus 10 includes a first extruder 30 and a second extruder 60, preferably arranged in close proximity in a stacked relationship as shown. The first extruder 30 has an inlet 32 for receiving a first rubber composition A as described in more detail, below. The second extruder 60 has an inlet 62 for receiving a second rubber composition B as described in more detail, below. The first or second extruder 30,60 may comprise any commercial extruder suitable for processing of rubber or elastomer compounds. The extruder may comprise a commercially available extruder commonly known by those skilled in the art as a pin type extruder, a twin screw or a single screw extruder, or a ring type of extruder. Preferably, the extruder has a length to diameter ratio (L/D) of about 5, but may range from about 3 to about 10.

The first extruder inlet 32 receives a first compound A, examples of which are described in more detail, below. The first extruder 30 functions to warm up a first compound A to the temperature in the range of about 80° C. to about 150° C., preferably about 90° C. to about 120° C., and to masticate the rubber composition as needed. The output end 34 of the first extruder 30 is connected to an inlet end 43 of a first gear pump 42. Compound A is thus first extruded by the first extruder 30 and then pumped by the first gear pump 42 into a rotatable housing for facilitating flow into a coextrusion nozzle 100. The first gear pump 42 functions as a metering device and a pump and may have gears such as planetary gears, bevel gears or other gears.

The second extruder inlet 62 receives a second compound B, examples of which are described in more detail, below. The second extruder 60 functions to warm up the second compound B to the temperature in the range of about 80° C. to about 150° C., preferably about 90° C. to about 120° C., and to masticate the rubber composition as needed. The output end 64 of the second extruder 60 is connected to an inlet end 45 of a second gear pump 44. Compound B is thus extruded by the second extruder 60 and then pumped by the second gear pump 44, which functions as a metering device and a pump and may have gears such as planetary gears, bevel gears or other gears.

The first and second gear pumps 42,44 are preferably placed in close proximity to each other so that the outlet channels 46,48 of the first and second gear pumps are also in close proximity, as shown in FIG. 2. The outlet channels 46,48 are fed into a first and second transition channel 66,68 which have a horizontal portion followed by a vertical portion 67,69 prior to entering a rotatable applicator head 70.

### Rotatable Applicator Head

The rotatable applicator head 70 is rotatable about the Z axis, allowing the nozzle 100 to pivot or rotate. The compound A and compound B flow streams 67,69 enter the rotatable applicator head 70 in a direction parallel with the Z axis. The A and B flow streams 67,69 are decreased in area and angled downwardly prior to entering coextrusion nozzle 100.

The rotatable applicator head can rotate in the range of about, 360 degrees, or more typically about +/−150 degrees from the center position. Because the rubber material changes direction prior to entering the rotatable applicator head, the flow remains unaffected by the rotation of the applicator head. Since rubber or elastomers have memory, changing direction of the rubber material prior to rotation prevents the material from curling or otherwise having an undesirable non-uniform flow.

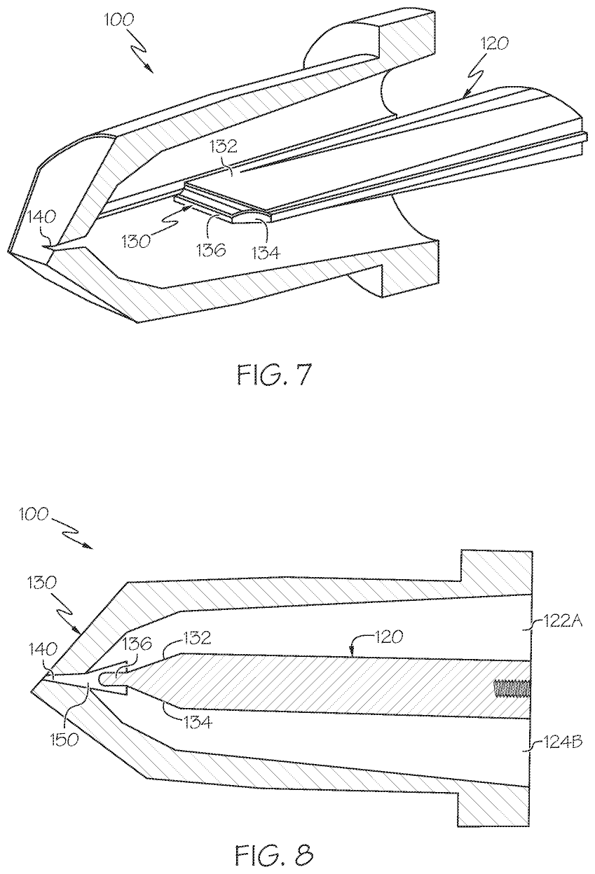

FIGS. 7-8 illustrate a coextrusion nozzle 100 suitable for use with the dual compound extruder apparatus 10 of the present invention. The coextrusion nozzle 100 is useful for forming a coextruded or dual compound continuous strip as shown in FIG. 6. The coextrusion nozzle 100 has a removable insert 120 that functions to divide the nozzle into a first and second flow passageway 122,124. The removable insert 120 is preferably rectangular in cross-sectional shape. The removable insert 120 has a distal end 130 with tapered ends 132,134 forming a nose 136. The nose 136 is positioned adjacent the nozzle die exit 140 and spaced a few millimeters from the die exit 140. The region between the nose 136 and the die exit 140 is a low volume coextrusion zone 150 that is high pressure. In the low volume coextrusion zone 150, compound A flowstream 122 merges (but does not mix with) compound B flowstream 124.

The dual compound extruder apparatus 10 with the coextrusion nozzle 100 produces a coextruded strip 230 having a first layer 232 of an impermeable compound such as butyl rubber or halobutyl rubber and a second layer 234 of a second compound B. The first layer 112 and the second layer 114 are not mixed together, and are joined together at an interface in a coextrusion zone of the nozzle. The coextrusion zone is located upstream of the nozzle die, where the compound A flow stream joins with the compound B flow stream under high pressure.

The dual compound extruder apparatus 10 can be used to vary the volume ratio of the first or impermeable compound to the second or ply compound of the coextruded strip, by varying the ratio of the speed of the first gear pump to the speed of the second gear pump. The dual compound extruder apparatus 10 can adjust the speed ratios on the fly, and due to the small residence time of the coextrusion nozzle, the apparatus has a fast response to a change in the compound ratios. This is due to the low volume of the coextrusion zone. The dual compound extruder apparatus 10 with the coextrusion nozzle may be used to coextrude a dual compound strip in a continuous manner onto a tire building drum, as shown in FIG. 5.

The width of the rubber strip output from the nozzle orifice is typically about 15 mm in width, but may vary in the range of about 5 mm to about 30 mm. The nozzle may be optionally heated to a temperature in the range of about 0 to about 230 degrees F., preferably in the range of about 0 to about 200 degrees F., using external or internal heaters (not shown).

As shown in FIG. 6, the nozzle 100 is oriented with respect to the tire building drum A, core (not shown) or other application surface typically at an angle θ in the range of about 0 to about 90 degrees, more typically in the range of about 35-90 degrees. It is preferred that the rubber output from the nozzle be oriented about 90 degrees relative to the application surface, although a may range from about 35-90 degrees.

The nozzle is oriented at an angle with respect to a tire building surface or core. The nozzle assembly is capable of translating in three directions in discrete index positions in order to accurately apply the rubber to the building surface. The support surface can be a toroid shaped core or a cylindrical shaped tire building drum, or any other desired shape. The primary advantage of applying the strip to a toroidally shaped surface is the finished part is accurately positioned in a green uncured state at the proper orientation to be molded without requiring any change in orientation from the condition in which the strip was initially formed.

The extrudate exits the nozzle in a strip form, having the desired shape of the exit orifice of the nozzle. If a drum or toroid is used as an applicator surface, as the drum or core rotates, a continuous annular strip may be formed. The nozzle can be indexed axially so to form the desired shape of the component. The nozzle can be controlled by a control system wherein the movement of the nozzle so that the multiple layers of strip dictates the shape of the desired tire component.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention.

What is claimed is:

1. A method for forming a tire having an innerliner, the method comprising the following steps:
forming a coextruded strip of a first compound and a second compound, wherein the first compound is an air impermeable compound; and
winding the coextruded strip onto a tire building drum while varying the ratio of the first compound to the second compound to form an inner liner layer of spirally wound coextruded strips.

2. The method of claim 1 wherein the second compound is a cross linkable diene rubber compound or mixtures thereof.

3. The method of claim 1 wherein the first compound is butyl rubber or mixtures thereof.

4. The method of claim 1 wherein the coextruded strip forming the middle portion of the inner liner layer has a volume ratio of 90% of the first compound to 10% of the second compound.

5. The method of claim 1 wherein the coextruded strip forming the lateral end portions of the inner liner layer has less than 10% of the first compound.

6. The method of claim 1 wherein the coextruded strip forming the lateral end portions of the inner liner layer has zero of the first compound.

7. The method of claim 1 wherein the coextruded strip forming the lateral end portions of the inner liner layer has greater than 90% of the second compound.

8. The method of claim 1 wherein the coextruded strip forming the lateral end portions of the inner liner layer has 100% of the second compound.

9. The method of claim 1 wherein the coextruded strip is formed by extruding a first compound through a first extruder and a first gear pump and into a first passageway of a coextrusion nozzle, extruding a second compound through a second extruder and a second gear pump and into a second passageway of the coextrusion nozzle, wherein the first and second passageways are joined together immediately upstream of the die outlet of the coextrusion nozzle, and forming a coextruded strip.

10. The method of claim 1 wherein the coextrusion nozzle has an insert which divides the nozzle into a separate first and second passageway.

11. The method of claim 1 wherein the coextrusion nozzle is one piece.

12. The method of claim 10 wherein the coextrusion nozzle is mounted on a rotatable head.

13. The method of claim 10 wherein the insert has a distal end for positioning adjacent a die outlet of the coextrusion nozzle, wherein the distal end has an elongated flat portion.

14. The method of claim 10 wherein the ratio of the volume of the first compound to the volume of the second compound is varied by changing the ratio of the speed of the first gear pump to the second gear pump.

15. The method of claim 13 wherein the ratio of the first gear pump to the second gear pump may be varied during operation of the system.

16. The method of claim 10 wherein the insert is removable.

17. The method of claim 2 wherein the strip has a rectangular or trapezoidal cross-sectional shape.

18. The method of claim 1 wherein the strip is formed in a continuous manner.

19. The method of claim 1 wherein the strip is applied in a continuous manner.

20. The method of claim 1 wherein the first compound is located radially inward of the second compound.

21. The method of claim 1 wherein the first compound is only partially encapsulated.

22. The method of claim 1 wherein the first compound is fully encapsulated
